(19) United States
(12) Patent Application Publication
(10) Pub. No.: US 2017/0100685 A1
(43) Pub. Date: Apr. 13, 2017

(54) OIL FILTER

(71) Applicant: Hong-Bin Ren, Zhoushan City (CN)

(72) Inventors: Xian-An Ren, Zhoushan City (CN); Hong-Bin Ren, Zhoushan City (CN)

(21) Appl. No.: 15/206,831

(22) Filed: Jul. 11, 2016

(30) Foreign Application Priority Data
Oct. 12, 2015 (CN) 201520826093.3

(51) Int. Cl. B01D 35/00; B01D 35/30; B01D 35/153

(52) U.S. Cl. CPC B01D 35/005; B01D 35/153; B01D 35/30; B01D 2201/0461; B01D 2201/30; B01D 2201/34; B01D 2201/167

(57) ABSTRACT

An oil filter includes a housing body, a housing cover, a check valve and a filter core. The filter core and the check valve are mounted in a filtering oil cavity of the housing body. The housing cover is mounted on the housing body and includes a top cover plate and a bottom cover plate. The top cover plate is engaged with the top of the housing body by compressing the outer periphery of the top cover plate to cover the top outer periphery of the housing body. The top cover plate is firmly attached to the bottom cover plate by compressing. The structural strength of the housing cover is enhanced and solves the damage and leaking problems for extending the life of the oil filter.

### BACKGROUND OF THE INVENTION

1. Field of the Invention

The present invention is related to an engine component, and more particularly to an oil filter.

2. Description of Related Art

CN utility model patent application No. CN201320368835.3 discloses an oil filter used in an engine including a body and a cover mounted on the body. A board is mounted in the body and has at least three oil filtering holes formed around an outer periphery of the board. A particle cavity is formed in the body and is located adjacent the top of the body. The conventional oil filter extends the oil flowing route to filter the oil particles by centrifugal force. Because the oil is cleaned by the centrifugal force, the particles flowing into and wearing off a crankshaft of the engine will be reduced. Thus, the useful life of the crankshaft of the engine can be prolonged.

However, the body does not have a sufficient structural strength, which causes oil leaking from the body when the oil filter is used in a shaking condition. Accordingly, the useful life of the oil filter will be reduced.

To overcome the shortcomings of the conventional oil filter, the present invention provides a new and novel oil filter to mitigate or obviate the aforementioned problems.

### SUMMARY OF THE INVENTION

The main objective of the invention is to provide an oil filter. The oil filter includes a housing body, a housing cover, a check valve and a filter core.

The filter core and the check valve are mounted in a filtering oil cavity of the housing body. The housing cover is mounted on the housing body and includes a top cover plate and a bottom cover plate. The top cover plate is engaged with the top of the housing body by compressing the outer periphery of the top cover plate to cover the top outer periphery of the housing body. The top cover plate is firmly attached on the bottom cover plate by compression.

The structural strength of the housing cover is stronger than the conventional oil filter, and not only facilitates ease in manufacture to reduce the cost of production, but also solves the damage and leaking problems for extending the life of the oil filter.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an oil filter in accordance with the present invention;

FIG. 2 is a top view of the oil filter in FIG. 1;

FIG. 3 is a cross-sectional side view along the line 3-3 in FIG. 2;

FIG. 4 is an exploded perspective view of the oil filter in FIG. 1;

FIG. 5 is an exploded perspective view of a filter core of the oil filter in FIG. 1; and

FIG. 6 is a top view of another embodiment of the oil filter in accordance with the present invention.

### DETAILED DESCRIPTION OF PREFERRED EMBODIMENT

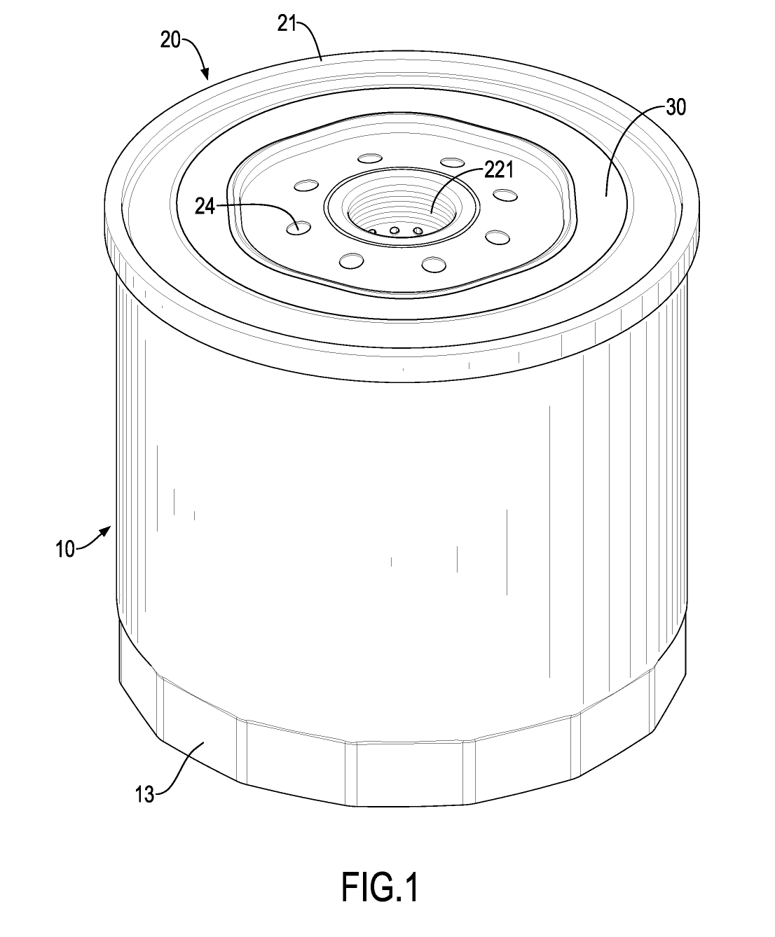

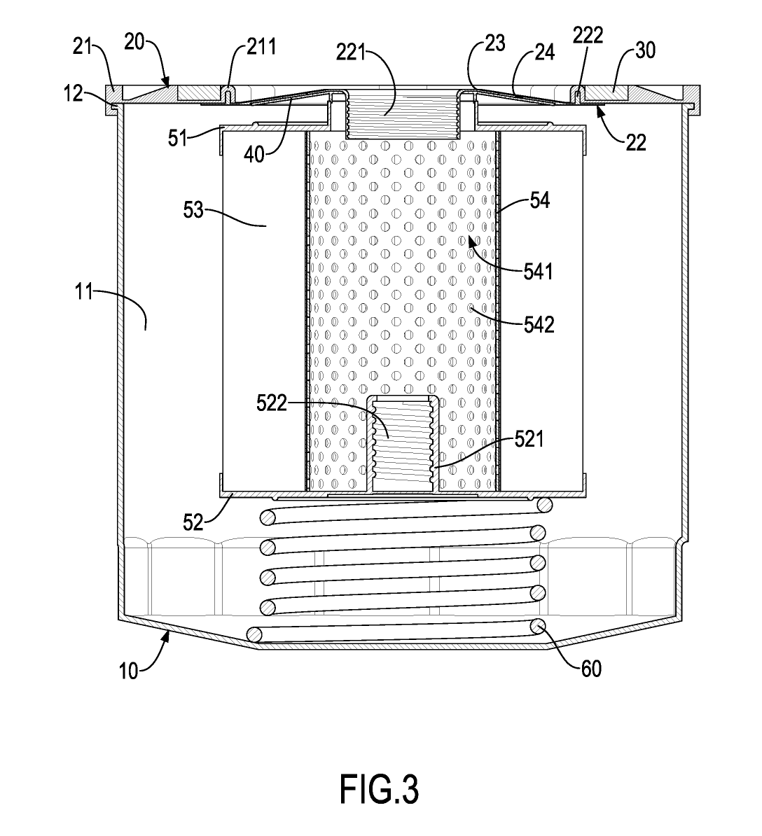

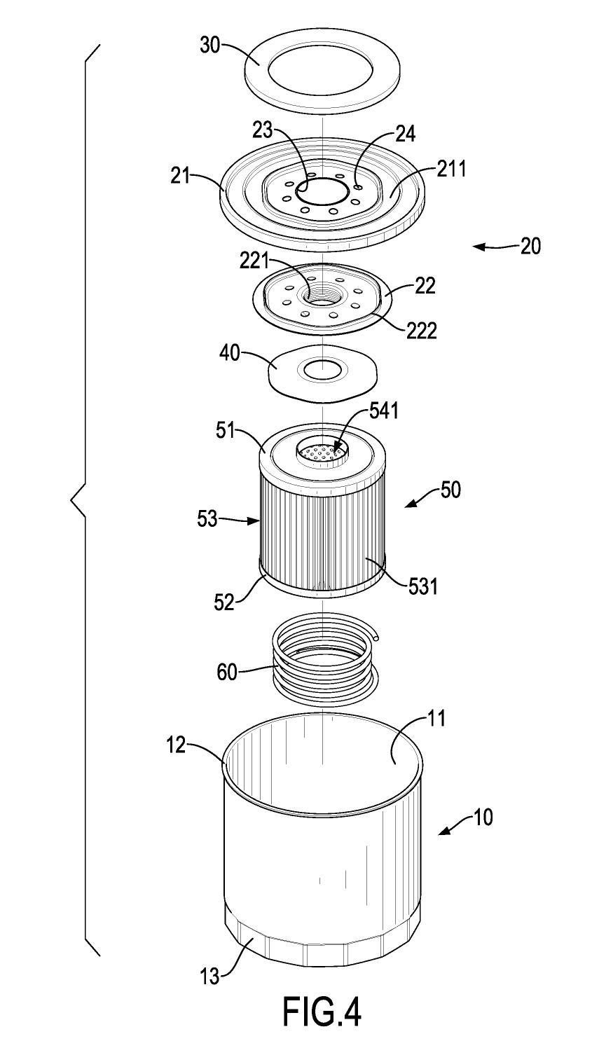

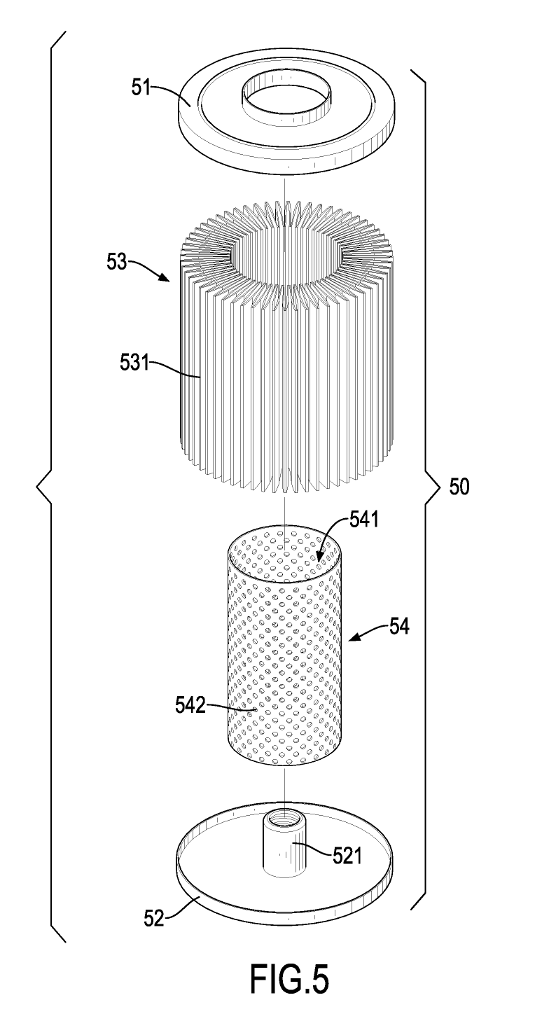

With reference to FIGS. 1 to 6, a preferred embodiment of an oil filter in accordance with the present invention has a housing body 10, a housing cover 20, a sealing ring 30, a check valve 40, a filter core 50 and a spring 60.

The housing body 10 has an inner wall, a filtering oil cavity 11 formed in the inner wall of the housing body 10, an opening 12 formed in the top of the housing body 10, and a rotating portion 13 formed on the bottom outer periphery of the housing body 10. The rotating portion 13 is polygonal in cross-section and may be used in rotating the housing body 10. Preferably, the housing body 10 further has at least one to three grooves formed in the outer surface of the housing body 10 for increasing the structural strength of the housing body 10. When amount of the grooves is more than two, the grooves are disposed in the outer surface of the housing body 10 at spaced intervals.

The housing cover 20 is mounted on the opening 12 of the housing body 10 and includes a top cover plate 21, a bottom cover plate 22, an outlet opening 23 and at least one oil inlet 24. The top cover plate 21 is engaged with the top of the housing body 10 by compressing the outer periphery of the top cover plate 21 to cover the top outer periphery of the housing body. Preferably, the top cover plate 21 is stacked on the top of the bottom cover plate 22; the bottom of the top cover plate 21 is firmly attached on the top of the bottom cover plate 22 by compression. The shape of the bottom of the top cover plate 21 corresponds to that of the top of the bottom cover plate 22. A sealing ring recess 211 is formed in the top of the top cover plate 21.

The outlet opening 23 is formed in the center of the housing cover 20. Preferably, the outlet opening 23 is formed through the centers of the top cover plate 21 and the bottom cover plate 22, and has a thread 221 formed around and on the inner surface of the outlet opening 23 for connecting with a discharging tube. A flange 222 is formed on the top of the bottom cover plate 22 and is engaged in the bottom of the top cover plate 21.

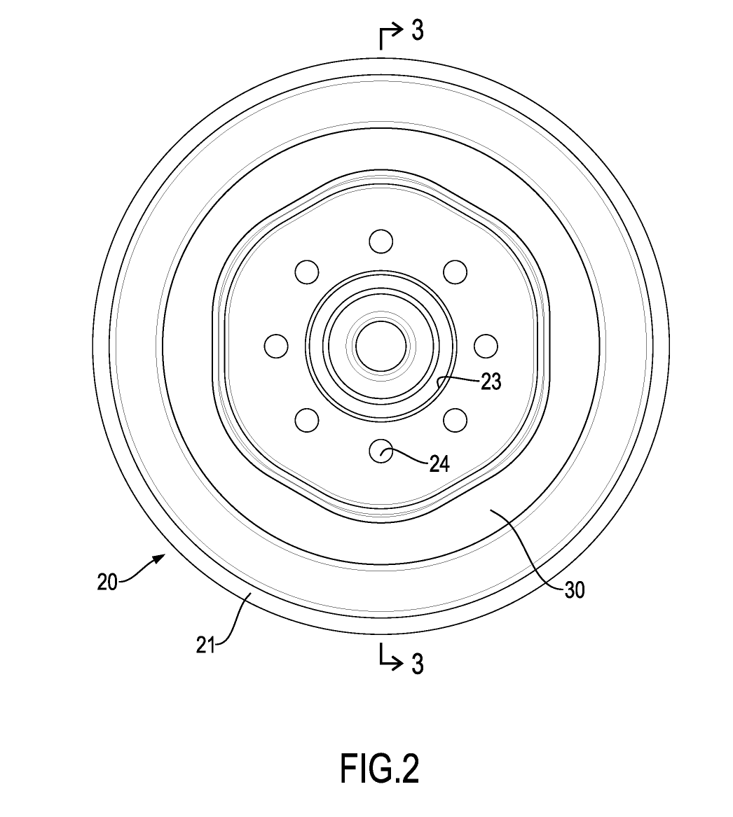

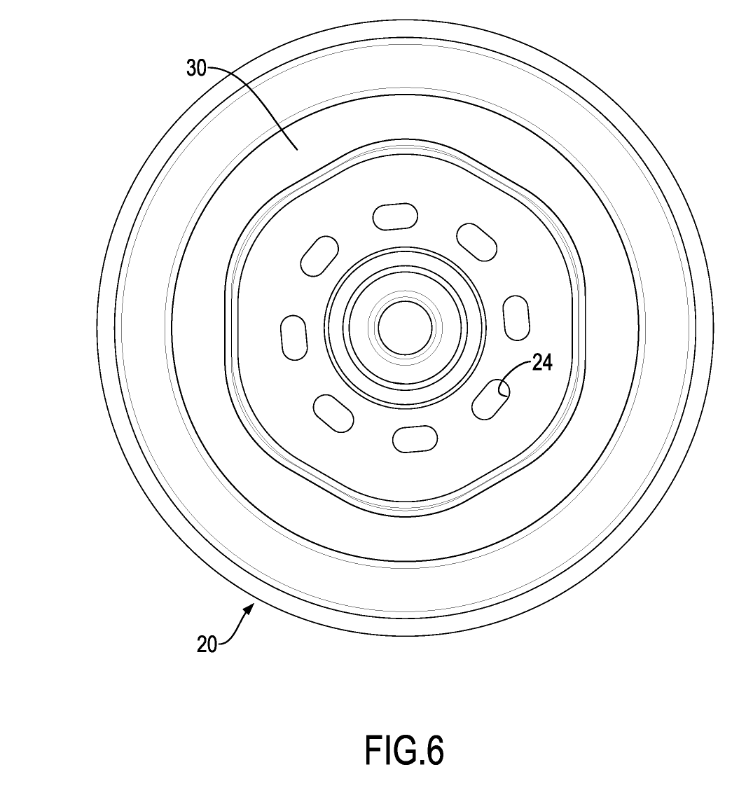

The at least one oil inlet 24 is formed and disposed in the housing cover 20. Preferably, the at least one oil inlet 24 is formed through the top cover plate 21 and the bottom cover plate 22, is located adjacent to the outlet opening 23, and is connected with the filtering oil cavity 11. Furthermore, a number of the oil inlet 24 is N, and N is a natural number from 5 to 10. The oil inlets 24 are disposed around the outlet opening 23 at spaced intervals. The positions of the oil inlets 24 of the top cover plate 21 correspond to those in the bottom cover plate 22. The contour of the oil inlets 24 can be circular, elliptical, rhombic, rectangular or slotted. In the preferred embodiments with reference to FIGS. 2 and 6, the contour of the oil inlets 24 is circular or slotted.

The sealing ring 30 is mounted in the sealing ring recess 211. When the oil filter is connected with a fixing unit, the sealing ring 30 can prevent oil leaking from the oil filter.

The check valve 40 is mounted between the housing cover 20 and the filter core 50. Preferably, the check valve 40 is a rubber disk. The oil inlets 24 are covered by the check valve 40 from the bottom of the bottom cover plate 22.

The filter core 50 is mounted in the filtering oil cavity 11 of the housing body 10 and includes a core cover 51, a core base 52, a filter paper 53 and a paper rack 54. The paper rack 54 is mounted on the core base 52. The check valve 40 is mounted between the bottom of the bottom cover plate 22 and the top of the core cover 51 of the filter core 50.

The filter paper 53 is mounted through the paper rack 54 and is located between the core cover 51 and the core base 52.

A fixing portion 521 is tubular, is formed on the top of the core base 52, and has an inner thread 522 formed around and on the inner surface of the fixing portion 521.

The filter paper 53 is folded as a barrel to form multiple troughs 531. The troughs 531 are disposed in the upright direction, and oil can be guided to flow into the filter paper 53 by the troughs 531.

A core cavity 541 and multiple through holes 542 are formed in the paper rack 54. The through holes 542 are disposed on the outer surface of the paper rack 54 and communicate with the core cavity 541.

The spring 60 is mounted between the bottom of the core base 52 and the inner bottom of the housing body 10. The spring 60 provides a pushing force to keep the filter core 50 connected with the check valve 40 and the housing cover 20.

When the oil filter is in use, dirty oil flows into the oil inlets 24 and pushes the outer periphery of the check valve 40 downward by gravity. Therefore, the dirty oil flows into and fills up the filtering oil cavity 11. If the dirty oil flows in reverse, the check valve 40 will be pressed by the pressure of the filled oil in the filtering oil cavity 11 and seals the oil inlets 24. Thus, the dirty oil cannot flow reversely into the oil inlets 24 but flows into the core cavity 541 and is filtered by the filter paper 53. The particles of the dirty oil will be kept in the filtering oil cavity 11.

An oil discharging tube can be mounted in the fixing portion 521 by threads. An oil outlet is formed in the oil discharging tube to discharge the filtered oil into an engine.

The engagement of the top cover plate 21 and the bottom cover plate 22 to form the housing cover is applied to the present invention as an advantage. The bottom cover plate 22 is covered by the top cover plate 21 and the flange 222 of the bottom cover plate 22 is engaged with the bottom of the top cover plate 21 by compression for securely fitting together. Therefore, the structural strength of the housing cover 20 is stronger than that of the conventional oil filter, and not only facilitates ease in manufacture to reduce the cost of production, but also solves the damage and leaking problems when the top cover plate 21 and the bottom cover plate 22 are welded to each other.

Due to the advantage of the housing cover, the oil filter is easily produced and cuts down the overall manufacturing cost, and the useful life of the oil filter can be prolonged.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An oil filter comprising:
a housing body having
an inner wall;
a filtering oil cavity formed in the inner wall of the housing body;
an opening formed in a top of the housing body;
a housing cover mounted on the opening of the housing body and including
a top cover plate engaged in the top of the housing body by compressing an outer periphery of the top cover plate to cover a top outer periphery of the housing body;
a bottom cover plate engaged with the top cover plate, a bottom of the top cover plate firmly attached to a top of the bottom cover plate by compression, the shape of the bottom of the top cover plate corresponding to the shape of the top of the bottom cover plate;
an outlet opening formed in a center of the housing cover and having a thread formed around and on an inner surface of the outlet opening; and
at least one oil inlet formed in the bottom cover plate of the housing cover and communicating with the filtering oil cavity;
a filter core mounted in the filtering oil cavity of the housing body; and
a check valve mounted between a bottom of the bottom cover plate and a top of the filter core.

2. The oil filter as claimed in claim 1, wherein a flange is formed on the top of the bottom cover plate and engaged in the bottom of the top cover plate, and a sealing ring recess is formed in a top of the top cover plate.

3. The oil filter as claimed in claim 2, wherein a sealing ring is mounted in the sealing ring recess.

4. The oil filter as claimed in claim 2, wherein the check valve is a rubber disk.

5. The oil filter as claimed in claim 1, wherein the filter core includes
a core cover;
a core base having a fixing portion being tubular and formed on a top of the core base, and the fixing portion having inner threads formed around an inner surface of the fixing portion;
a paper rack mounted on the core base and having a core cavity and multiple through holes formed in the paper rack, disposed on an outer surface of the paper rack, and communicating with the core cavity; and
a filter paper mounted through the paper rack, located between the core cover and the core base, and folded as a barrel to form multiple troughs; and
the check valve is mounted on a top of the core cover.

6. The oil filter as claimed in claim 2, wherein the filter core includes
a core cover;
a core base having a fixing portion being tubular and formed on a top of the core base, and the fixing portion having inner threads formed around an inner surface of the fixing portion;
a paper rack mounted on the core base and having a core cavity and multiple through holes formed in the paper rack, disposed on an outer surface of the paper rack, and communicating with the core cavity; and
a filter paper mounted through the paper rack, located between the core cover and the core base, and folded as a barrel to form multiple troughs; and
the check valve is mounted on a top of the core cover.

7. The oil filter as claimed in claim 3, wherein the filter core includes
a core cover;
a core base having a fixing portion being tubular and formed on a top of the core base, and the fixing portion having inner threads formed around an inner surface of the fixing portion;
a paper rack mounted on the core base and having a core cavity and multiple through holes formed in the paper rack, disposed on an outer surface of the paper rack, and communicating with the core cavity; and
a filter paper mounted through the paper rack, located between the core cover and the core base, and folded as a barrel to form multiple troughs; and
the check valve is mounted on a top of the core cover.

8. The oil filter as claimed in claim 4, wherein the filter core includes
a core cover;
a core base having a fixing portion being tubular and formed on a top of the core base, and the fixing portion having inner threads formed around the inner surface of the fixing portion;
a paper rack mounted on the core base and having a core cavity and multiple through holes formed in the paper rack, disposed on an outer surface of the paper rack, and communicating with the core cavity; and
a filter paper mounted through the paper rack, located between the core cover and the core base, and folded as a barrel to form multiple troughs; and
the check valve is mounted on a top of the core cover.

9. The oil filter as claimed in claim 1, wherein a number of the at least one oil inlet is N, N is a natural number from 5 to 10, and the oil inlets are disposed around the outlet opening at spaced intervals.

10. The oil filter as claimed in claim 2, wherein a number of the at least one oil inlet is N, N is a natural number from 5 to 10, and the oil inlets are disposed around the outlet opening at spaced intervals.

11. The oil filter as claimed in claim 3, wherein a number of the at least one oil inlet is N, N is a natural number from 5 to 10, and the oil inlets are disposed around the outlet opening at spaced intervals.

12. The oil filter as claimed in claim 4, wherein a number of the at least one oil inlet is N, N is a natural number from 5 to 10, and the oil inlets are disposed around the outlet opening at spaced intervals.

13. The oil filter as claimed in claim 1, wherein the housing body further has a rotating portion formed on a bottom outer periphery of the housing body and being polygonal in cross section.

14. The oil filter as claimed in claim 2, wherein the housing body further has a rotating portion formed on a bottom outer periphery of the housing body, and the rotating portion is polygonal in cross section and may be used in rotating the housing body.

15. The oil filter as claimed in claim 3, wherein the housing body further has a rotating portion formed on a bottom outer periphery of the housing body, and the rotating portion is polygonal in cross section and may be used in rotating the housing body.

16. The oil filter as claimed in claim 4, wherein the housing body further has a rotating portion formed on a bottom outer periphery of the housing body, and the rotating portion is polygonal in cross section and may be used in rotating the housing body.

17. The oil filter as claimed in claim 5, wherein a spring is mounted between a bottom of the core base and an inner bottom of the housing body.

18. The oil filter as claimed in claim 6, wherein a spring is mounted between a bottom of the core base and an inner bottom of the housing body.

19. The oil filter as claimed in claim 7, wherein a spring is mounted between a bottom of the core base and an inner bottom of the housing body.

20. The oil filter as claimed in claim 8, wherein a spring is mounted between a bottom of the core base and an inner bottom of the housing body.
